(19) United States
(12) Patent Application Publication
(10) Pub. No.: US 2026/0208307 A1
(43) Pub. Date: Jul. 23, 2026

(54) DETACHABLE FIXTURE DEVICE

(71) Applicant: GRAND MATE CO., LTD., Taichung City (TW)

(72) Inventors: CHIN-YING HUANG, Taichung City (TW); HSIN-MING HUANG, Taichung City (TW); HSING-HSIUNG HUANG, Taichung City (TW); YEN-JEN YEH, Taichung City (TW)

(73) Assignee: GRAND MATE CO., LTD., Taichung City (TW)

(21) Appl. No.: 19/026,462

(22) Filed: Jan. 17, 2025

(51) Int. Cl. B23Q 3/18

(52) U.S. Cl. CPC B23Q 3/183

(57) ABSTRACT

A detachable fixture device is mounted on a base of a machining center, the base including a rotary table and a dispensing unit that is disposed on a top surface of the rotary table. The detachable fixture device includes an adapter plate and a fixture module. The fixture module includes a base plate and a plurality of fixtures, the base plate detachably disposed on a top surface of the adapter plate. With the detachable design of the base plate of the fixture module and the adapter plate, when replacing the fixture module, the fixture module could be quickly detached from the adapter plate to engage another fixture module with the adapter plate, significantly improving the overall machining efficiency.

### BACKGROUND OF THE INVENTION

### Technical Field

The present invention relates generally to a machining center, and more particularly to a detachable fixture device.

### Description of Related Art

With the increasing complexity of machined parts, machining equipment is required not only for machining precision but also for machining efficiency, production quality, and adaptability for various materials. Under this trend, a wide range of machining processes have been developed, including three-axis machining, four-axis machining, five-axis machining, etc.

Taking a five-axis machining center as an example, in the current technology, a five-axis machining center necessitates repositioning when processing workpieces with different structures. The positioning process involves fixture setup, jig setup, alignment, and calibration, each requiring precise and accurate operations to ensure the accuracy of workpiece machining.

However, the repositioning process of replacing workpieces with different structures includes multiple steps that require precise and accurate operations, leading to vast time consumption when replacing workpieces with different structures, and, in turn, the overall processing time is increased and production efficiency is decreased. In addition, inaccurate positioning could result in reduced precision during subsequent processing, thereby affecting the quality of machined workpieces.

### BRIEF SUMMARY OF THE INVENTION

In view of the above, the primary objective of the present invention is to provide a detachable fixture device, which could improve the operational efficiency of switching machined workpieces.

The present invention provides a detachable fixture device mounted on a base of a machining center. The base includes a rotary table and a dispensing unit that is disposed on a top surface of the rotary table and has a plurality of fluid outlets. The detachable fixture device includes an adapter plate and a fixture module. The adapter plate has a recess and a plurality of first fluid channels. The recess is located on a bottom surface of the adapter plate and is configured to fit around the dispensing unit. The plurality of first fluid channels is located in an interior of the adapter plate, and each first fluid channel has a first fluid channel inlet and a first fluid channel outlet. The plurality of first fluid channel inlets are formed within the recess in positions corresponding to the plurality of fluid outlets. The plurality of first fluid channel inlets respectively communicate with the plurality of fluid outlets, and the plurality of first fluid channel outlets are formed on a top surface of the adapter plate. The fixture module includes a base plate and a plurality of fixtures. The base plate is detachably disposed on the top surface of the adapter plate and has a plurality of second fluid channels that are formed in an interior of the base plate, each second fluid channel having a second fluid channel inlet and a second fluid channel outlet. The plurality of second fluid channel inlets are formed on a bottom surface of the base plate in positions corresponding to the plurality of first fluid channel outlets. The plurality of second fluid channel inlets respectively communicate with the plurality of first fluid channel outlets, and the plurality of second fluid channel outlets are formed on a top surface of the base plate. The plurality of fixtures are disposed on the top surface of the base plate, each fixture having a fluid inlet communicating with one corresponding second fluid channel outlet.

With the detachable design of the base plate of the fixture module and the adapter plate, when replacing the fixture module, the fixture module could be quickly detached from the adapter plate to engage another fixture module with the adapter plate, significantly improving the overall machining efficiency.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a detachable fixture device according to a first embodiment of the present invention, illustrating that a first fixture module is engaged with an adapter plate;

FIG. 2 is a partially exploded view of the detachable fixture device according to the first embodiment of the present invention;

FIG. 3 is a perspective view of a base of the detachable fixture device according to the first embodiment of the present invention;

FIG. 4 is a partially exploded view of the detachable fixture device according to the first embodiment of the present invention, illustrating that the adapter plate is detached from the base;

FIG. 5 is a schematic view of the engagement of the adapter plate and the base of the detachable fixture device according to the first embodiment of the present invention, illustrating an alignment element fits an engaging slot;

FIG. 6 is a side view of the adapter plate of the detachable fixture device according to the first embodiment of the present invention;

FIG. 7 is a sectional view along 7-7 line in FIG. 6;

FIG. 8 is a partially exploded view of the detachable fixture device according to the first embodiment of the present invention, illustrating that a first fixture module is detached from the adapter plate;

FIG. 9 is a top view of a first base plate of the detachable fixture device according to the first embodiment of the present invention;

FIG. 10 is a perspective view of the detachable fixture device according to the first embodiment of the present invention, illustrating that a second fixture module is engaged with the adapter plate;

FIG. 11 is a partially exploded view of the detachable fixture device according to the first embodiment of the present invention;

FIG. 12 is a partially exploded view of the detachable fixture device according to the first embodiment of the present invention, illustrating that the second fixture module is detached from the adapter plate; and

FIG. 13 is a top view of a second base plate of the detachable fixture device according to the first embodiment of the present invention.

### DETAILED DESCRIPTION OF THE INVENTION

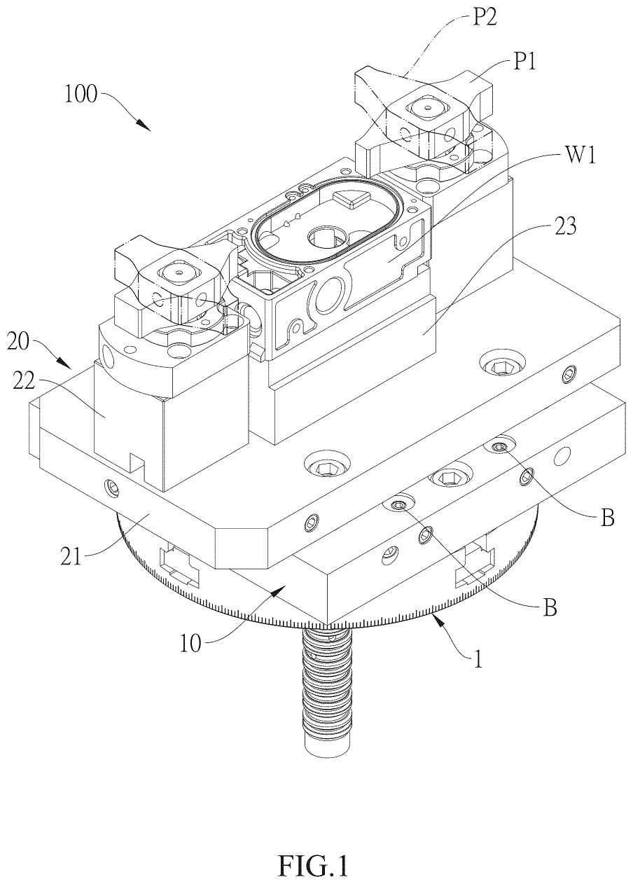

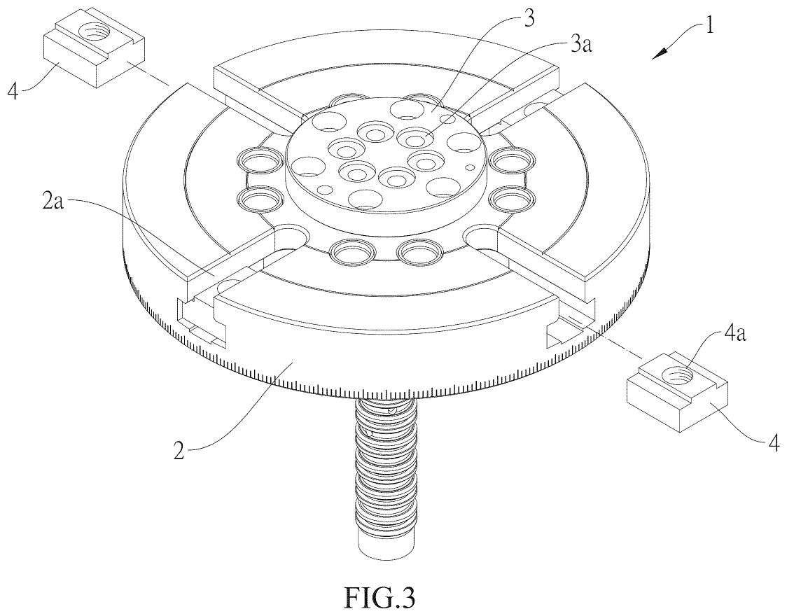

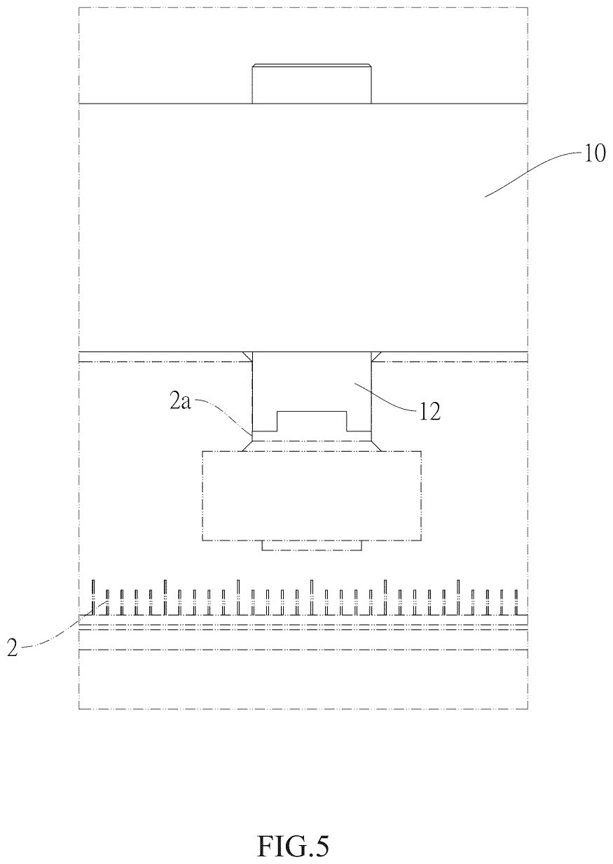

A detachable fixture device 100 according to a first embodiment of the present invention is illustrated in FIG. 1 to FIG. 13, wherein the detachable fixture device 100 is mounted on a base 1 of a machining center (not shown), which is a five-axis machining center in the current embodiment. The base 1 includes a rotary table 2 and a dispensing unit 3 that is disposed on a top surface of the rotary table 2. The dispensing unit 3 has a plurality of fluid outlets 3a that could be used for the passage of liquids or gases in the current embodiment. The detachable fixture device 100 includes an adapter plate and a fixture module that is selectable from one of a plurality of different fixture modules. The plurality of fixture modules includes a first fixture module 20 and a second fixture module 60, which are respectively configured to clamp different machining workpieces, or to clamp different machining surfaces of the same workpiece. In the current embodiment, a workpiece clamped by the first fixture module 20 is a first workpiece W1 as an example, and a workpiece clamped by the second fixture module 60 is a second workpiece W2 as an example.

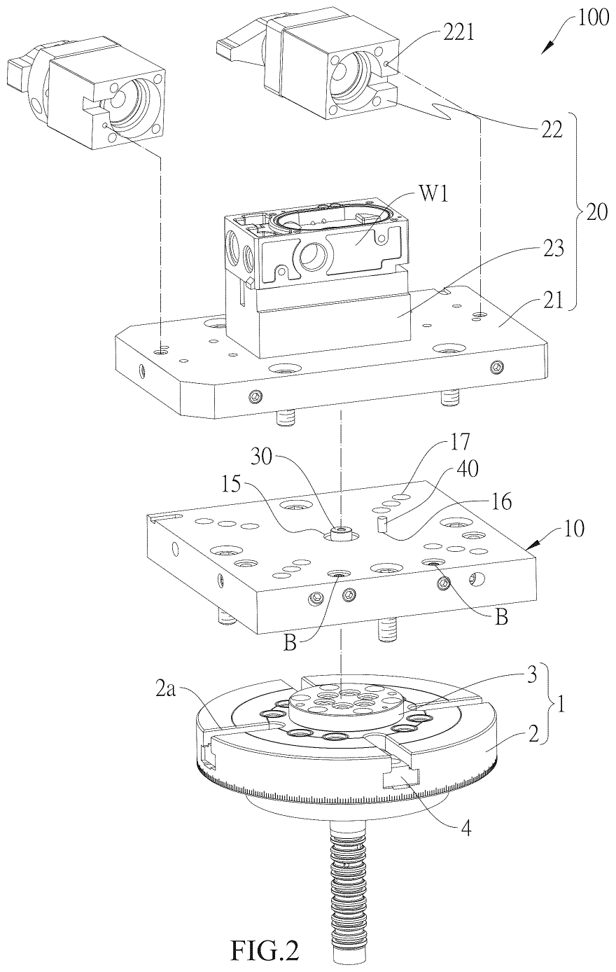

As shown in FIG. 2 to FIG. 5, the adapter plate is engaged with the base 1; more specifically, the rotary table 2 has a plurality of engaging slots 2a, each engaging slot 2a being provided with a nut 4 that has a thread hole 4a. The adapter plate 10 has a plurality of engaging holes 11 in positions corresponding to the plurality of engaging slots 2a. When the adapter plate 10 and the rotary table 2 are engaged, the adapter plate 10 and the rotary table 2 are engaged with the plurality of engaging slots 2a through a plurality of engaging elements 5 respectively passing through the plurality of engaging holes 11 and threading into the plurality of thread holes 4a. In the current embodiment, each engaging element 5 is a bolt. An alignment element 12 is disposed on the bottom surface of the adapter plate 10 in a position corresponding to one of the engaging slots 2a. When the adapter plate 10 and the rotary table 2 are engaged, the alignment element 12 is inserted into one corresponding engaging slot 2a and fits a slot wall of the corresponding engaging slot 2a, and then the adapter plate 10 is engaged with the rotary table 2 through the plurality of engaging elements, thereby avoiding misalignment when the adapter plate 10 is assembled to the rotary table, and improving the accuracy and stability of machining process.

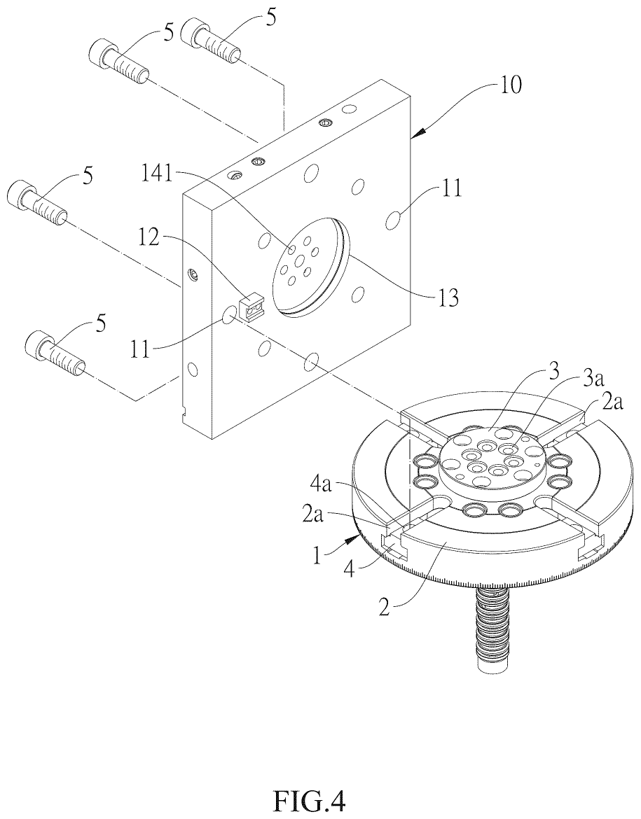

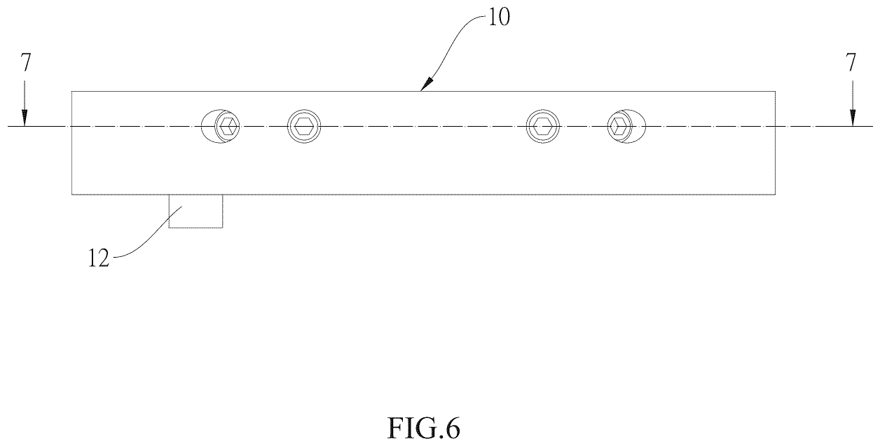

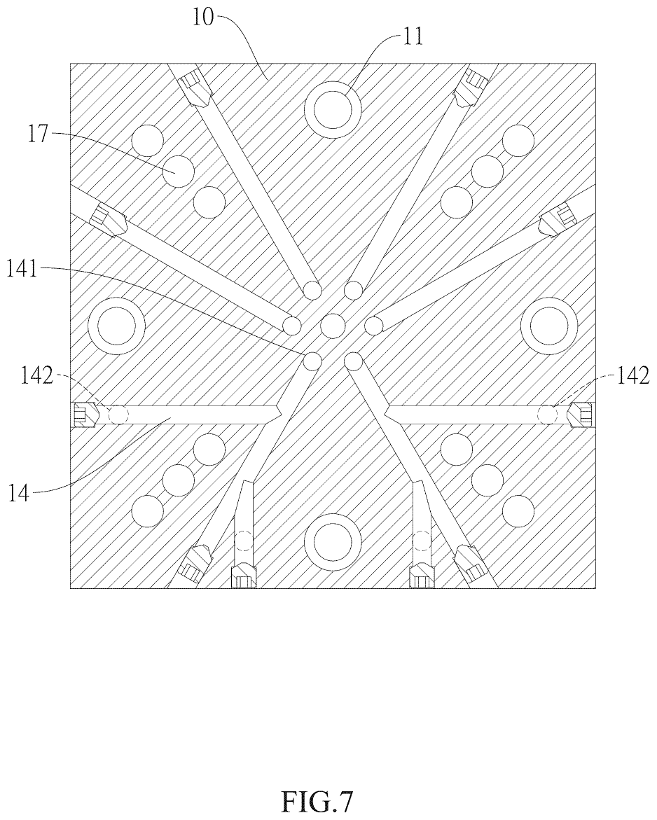

As shown in FIG. 4, FIG. 6, and FIG. 7, the adapter plate 10 has a recess 13 and a plurality of first fluid channels 14. The recess 13 is located on a bottom surface of the adapter plate 10 and is configured to fit around the dispensing unit 3. The plurality of first fluid channels 14 are located in an interior of the adapter plate 10, each first fluid channel 14 having a first fluid channel inlet 141 and a first fluid channel outlet 142. The plurality of first fluid channel inlets 141 are formed within the recess 13 in positions corresponding to the plurality of fluid outlets 3a, and the plurality of first fluid channel inlets 141 respectively communicate with the plurality of fluid outlets 3a. The plurality of first fluid channel outlets 142 are formed on a top surface of the adapter plate 10.

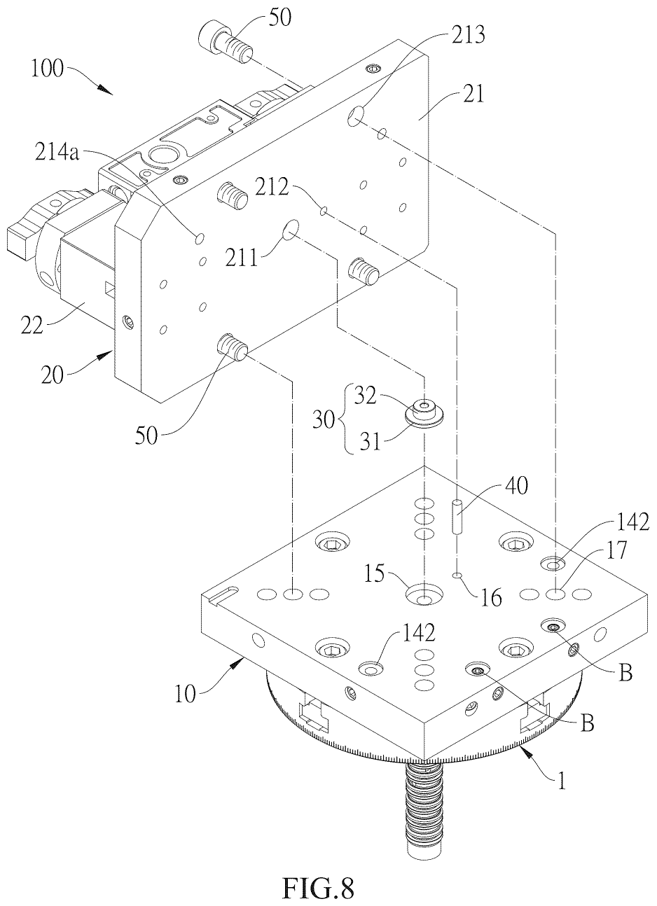

As shown in FIG. 8, the first fixture module 20 includes a first base plate 21 that is detachably disposed on the top surface 10 of the adapter plate 10. More specifically, the top surface of the adapter plate 10 has at least one upper positioning hole. The first base plate 21 has at least one lower positioning hole in a position corresponding to the at least one upper positioning hole, and the adapter plate 10 and the first base plate 21 are positioned through at least one positioning element engaging in the at least one upper positioning hole and the at least one lower positioning hole, thereby positioning the first base plate 21 relative to the adapter plate 10 for installation. In the current embodiment, the at least one upper positioning hole includes a first upper positioning hole 15 located in a center of the top surface of the adapter plate 10. The at least one lower positioning hole includes a first lower positioning hole 211 that corresponds to the first upper positioning hole 15 and is located in a center of a bottom surface of the first base plate 21. The at least one positioning element includes a first positioning element 30 that has a head 31 and a body 32 connected to each other, with the head 31 inserted into the first upper positioning hole 15 and the body inserted into the first lower positioning hole 211.

The at least one upper positioning hole further includes a second upper positioning hole 16, and the at least one lower positioning hole further includes a second lower positioning hole 212 that is disposed in a position corresponding to the second upper positioning hole 16. The at least one positioning element includes a second positioning element 40 that is a positioning pin, one end of the second positioning element 40 being inserted into the second upper positioning hole 16 and the other end of the second positioning element 40 being inserted into the second lower positioning hole 212. With the design of the first positioning element 30 and the second positioning element 40, when the first base plate 21 is assembled onto the adapter plate 10, the first base plate 21 could be precisely aligned with the adapter plate 10 to prevent the first base plate 21 from rotating or displacing relative to the adapter plate 10, thereby improving the accuracy and stability of machining process.

In the current embodiment, the manufacturing process for creating the first upper positioning hole 15 and the second upper positioning hole 16 are as follows. When the adapter plate 10 that does not have the first upper positioning hole 15 and the second upper positioning hole 16 is engaged with the rotary table 2, the adapter plate 10 could be machined to form the first upper positioning hole 15 by using a tool of the machining center. Then, taking a center of the first upper positioning hole 15 as an origin of machining, the second upper positioning hole 16 is machined around the first upper positioning hole 15. Through the process, the adapter plate 10 is produced with the first upper positioning hole 15 and the second upper positioning hole 16.

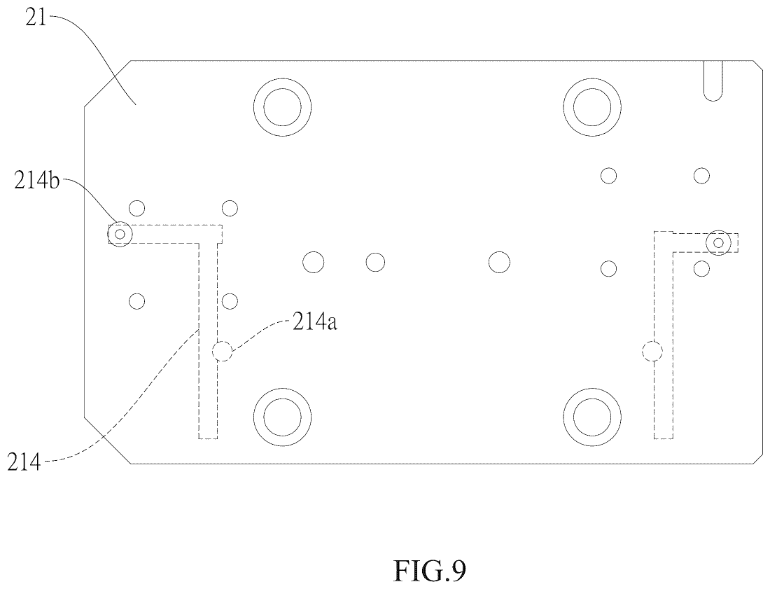

As shown in FIG. 8 and FIG. 9, the top surface of the adapter plate 10 is provided with a plurality of thread holes 17 that are arranged radially outward from the center of the top surface of the adapter plate 10. The first base plate 21 has a plurality of through holes 213 in positions corresponding to a part of the plurality of thread holes 17. The first base plate 21 and the adapter plate 10 are engaged through a plurality of engaging elements 50 passing through the plurality of through holes 213 and threading into the corresponding thread holes 17, each engaging element 50 being a bolt, for fastening the first base plate 21 to the adapter plate 10. In the current embodiment, the first base plate 21 has a plurality of second fluid channels 214 that are formed in an interior of the first base plate 21, each second fluid channel 214 having a second fluid channel inlet 214a and a second fluid channel outlet 214b. The plurality of second fluid channel inlets 214a are formed on the bottom surface of the first base plate 21 in positions corresponding to the plurality of first fluid channel outlets 142, the plurality of second fluid channel inlets 214a respectively communicating with the plurality of first fluid channel outlets 142. The plurality of second fluid channel outlets 214b are formed on a top surface of the first base plate 21, wherein, to prevent fluid leakage, the first fluid channel outlets 142 unused could be blocked by blocking elements B.

As shown in FIG. 1 to FIG. 2, the first fixture module 20 further includes a plurality of first fixtures 22 and a first jig 23, wherein the plurality of first fixtures 22 are disposed on the top surface of the first base plate 21, the first jig 23 is disposed on the first base plate 21 and is located between the plurality of first fixtures 22, and the first workpiece W1 is positioned on the first jig 23. In the current embodiment, the first fixtures 22 clamp and release the first workpiece W1 through hydraulic pressure; in an embodiment, the first fixtures 22 could also clamp and release the first workpiece W1 through pneumatic pressure.

More specifically, each first fixture 22 has a fluid inlet 221 communicating with one corresponding second fluid channel outlet 214b. When hydraulic oil flows through a part of the fluid outlets 3a, through each first fluid channel 14 into each second fluid channel 214, and finally is delivered to each first fixture 22 through each fluid inlet 221, each first fixture 22 is pressurized in a locked position P1 (FIG. 1, solid line) to secure the first workpiece W1. When the first workpiece W1 does not need to be machined, the hydraulic oil is stopped injecting into each fluid inlet 221, a restoring component (not shown) of each first fixture 22 pushes each first fixture 22 back to a released position P2 (FIG. 1, dashed line) to release the first workpiece W1.

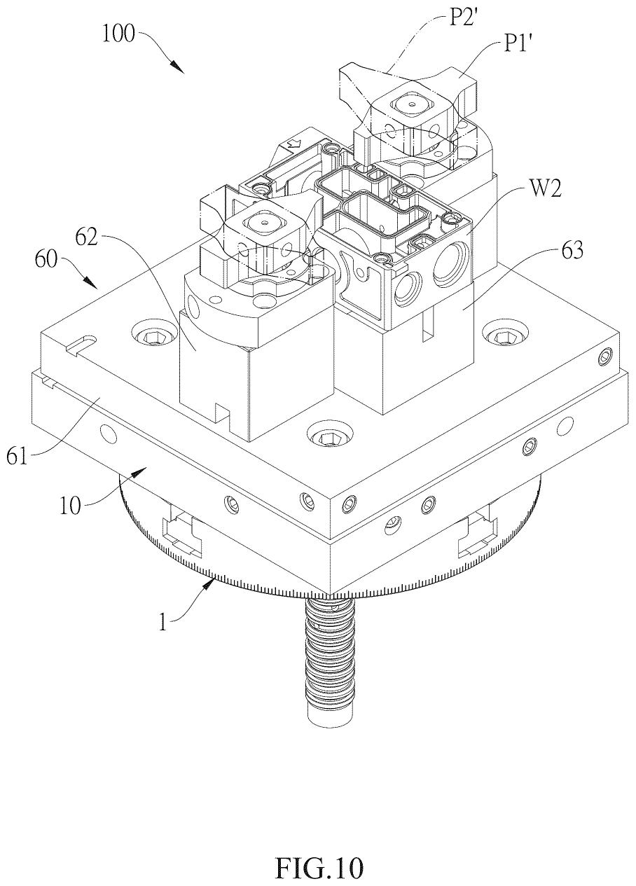

As shown in FIG. 10 to FIG. 13, when the machining center necessitates replacing the fixture module, it simply needs to detach the first fixture module 20 from the adapter plate 10 and then engage the second fixture module 60 with the adapter plate 10 to complete the replacement of the fixture module. The following are discussed with reference to the differences of the second fixture module 60.

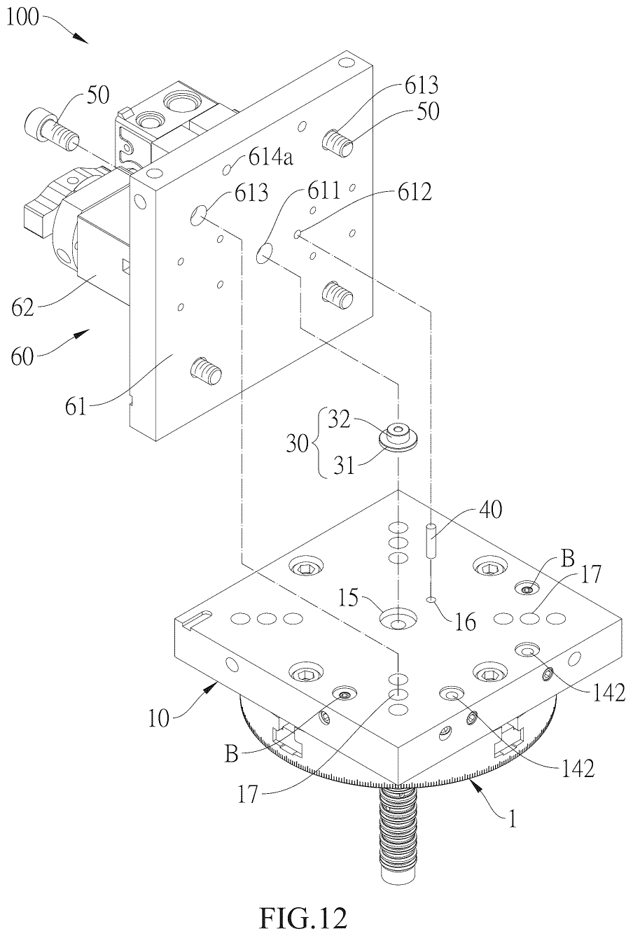

As shown in FIG. 12, the second fixture module 60 includes a second base plate 61 that is detachably disposed on the top surface of the adapter plate 10. More specifically, the adapter plate 10 has the first upper positioning hole 15 that is located in the center of the top surface of the adapter plate 10. The second base plate 61 has a first lower positioning hole 611 that corresponds to the first upper positioning hole 15 and is located in a center of a bottom surface of the second base plate 61. The at least one positioning element includes the first positioning element 30 that has the head 31 and the body 32 connected to each other, with the head 31 inserted into the first upper positioning hole 15 and the body inserted into the first lower positioning hole 611.

In the current embodiment, the adapter plate 10 has the second upper positioning hole 16 that is located around the first upper positioning hole 15. The second base plate 16 has a second lower positioning hole 612 that is disposed in a position corresponding to the second upper positioning hole 16. The at least one positioning element includes the second positioning element 40 that is a positioning pin, one end of the second positioning element 40 being inserted into the second upper positioning hole 16 and the other end of the second positioning element 40 being inserted into the second lower positioning hole 612. With the design of the first positioning element 30 and the second positioning element 40, when the second base plate 61 is assembled onto the adapter plate 10, the second base plate 61 could be precisely aligned with the adapter plate 10 to prevent the second base plate 61 from rotating or displacing relative to the adapter plate 10, thereby improving the accuracy and stability of machining process.

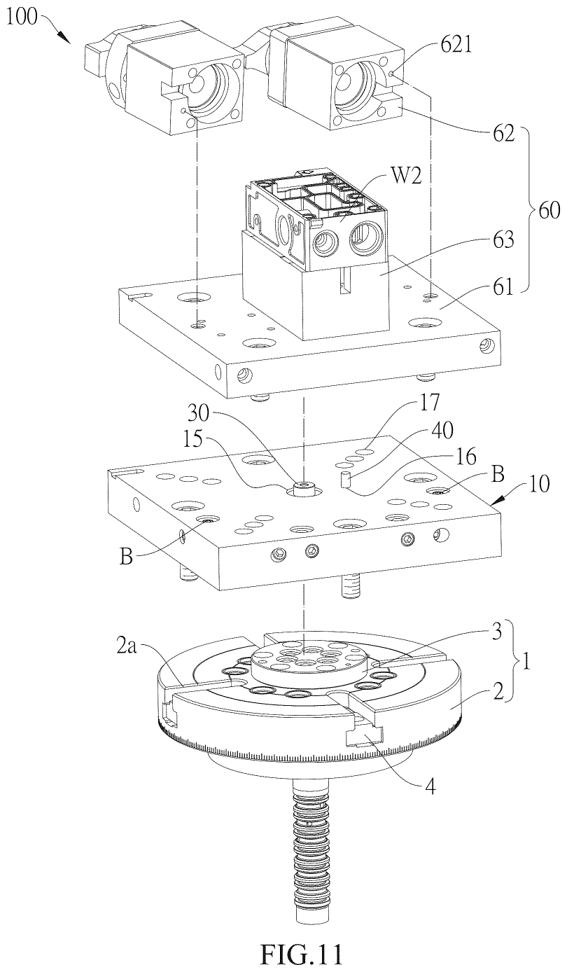

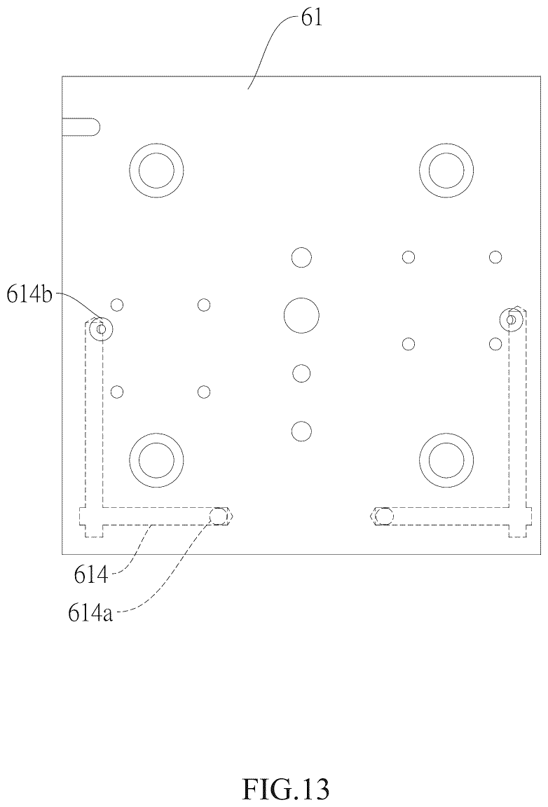

As shown in FIG. 11 and FIG. 12, the top surface of the adapter plate 10 is provided with the plurality of thread holes 17 that are arranged radially outward from the center of the top surface of the adapter plate 10. The second base plate 61 has a plurality of through holes 613 in positions corresponding to a part of the plurality of thread holes 17. The second base plate 61 and the adapter plate 10 are engaged through a plurality of engaging elements 50 passing through the plurality of through holes 613 and threading into the corresponding thread holes 17 for fastening the second base plate 61 to the adapter plate 10. As shown in FIG. 13, in the current embodiment, the second base plate 61 has a plurality of second fluid channels 614 that are formed in an interior of the second base plate 61, each second fluid channel 614 having a second fluid channel inlet 614a and a second fluid channel outlet 614b. The plurality of second fluid channel inlets 614a are formed on the bottom surface of the second base plate 61 in positions corresponding to the plurality of first fluid channel outlets 142, the plurality of second fluid channel inlets 614a communicating with the plurality of first fluid channel outlets 142. The plurality of second fluid channel outlets 614b are formed on a top surface of the second base plate 61, wherein, to prevent fluid leakage, the first fluid channel outlets 142 unused could be blocked by blocking elements B.

As shown in FIG. 10 and FIG. 11, the second fixture module 60 further includes a plurality of second fixtures 62 and a second jig 63, wherein the plurality of second fixtures 62 are disposed on the top surface of the second base plate 61, the second jig 63 is disposed on the second base plate 61 and is located between the plurality of second fixtures 62, and the second workpiece W2 is positioned on the first jig 63. In the current embodiment, the second fixtures 62 clamp and release the second workpiece W2 through hydraulic pressure; in an embodiment, the second fixtures 62 could also clamp and release the second workpiece W2 through pneumatic pressure.

More specifically, each second fixture 62 has a fluid inlet 621 communicating with one corresponding second fluid channel outlet 614b. When hydraulic oil flows through a part of the fluid outlets 3a, through each first fluid channel 14 into each second fluid channel 614, and finally is delivered to each second fixture 62 through each fluid inlet 621, each second fixture 62 is pressurized in a locked position P1′ (FIG. 10, solid line) to secure the second workpiece W2. When the second workpiece W2 does not need to be machined, the hydraulic oil is stopped injecting into each fluid inlet 621, a restoring component (not shown) of each second fixture 62 pushes each second fixture 62 back to a released position P2′ (FIG. 10, dashed line) to release the second workpiece W2.

With the aforementioned design of the adapter plate 10, upon completion of machining the first workpiece W1 of the first fixture module 20 and beginning of machining the second workpiece W2 of the second fixture module 60, it simply needs to detach the first fixture module 20 from the adapter plate 10 and then engage the second fixture module 60 with the adapter plate 10 to complete the replacement of the fixture module, significantly improving the overall machining efficiency.

It is noteworthy that, by providing the plurality of thread holes 17 on the top surface of the adapter plate 10, the adapter plate 10 is adapted to different fixture modules for assembly, improving flexibility and compatibility upon installation.

It must be pointed out that the embodiments described above are only some preferred embodiments of the present invention. All equivalent structures which employ the concepts disclosed in this specification and the appended claims should fall within the scope of the present invention.

What is claimed is:

1. A detachable fixture device, mounted on a base of a machining center, the base including a rotary table and a dispensing unit that is disposed on a top surface of the rotary table and has a plurality of fluid outlets; the detachable fixture device comprising:
an adapter plate, having a recess and a plurality of first fluid channels, the recess located on a bottom surface of the adapter plate and configured to fit around the dispensing unit, the plurality of first fluid channels located in an interior of the adapter plate, each first fluid channel having a first fluid channel inlet and a first fluid channel outlet; the plurality of first fluid channel inlets formed within the recess in positions corresponding to the plurality of fluid outlets, the plurality of first fluid channel inlets respectively communicating with the plurality of fluid outlets; the plurality of first fluid channel outlets formed on a top surface of the adapter plate; and
a fixture module, including a base plate and a plurality of fixtures, the base plate detachably disposed on the top surface of the adapter plate and having a plurality of second fluid channels that are formed in an interior of the base plate, each second fluid channel having a second fluid channel inlet and a second fluid channel outlet; the plurality of second fluid channel inlets formed on a bottom surface of the base plate in positions corresponding to the plurality of first fluid channel outlets, the plurality of second fluid channel inlets respectively communicating with the plurality of first fluid channel outlets; the plurality of second fluid channel outlets formed on a top surface of the base plate; the plurality of fixtures disposed on the top surface of the base plate, each fixture having a fluid inlet communicating with one corresponding second fluid channel outlet.

2. The detachable fixture device as claimed in claim 1, wherein the rotary table has a plurality of engaging slots; the adapter plate has a plurality of engaging holes in positions corresponding to the plurality of engaging slots; the adapter plate and the rotary table are engaged through a plurality of engaging elements respectively passing through the plurality of engaging holes and the plurality of engaging slots.

3. The detachable fixture device as claimed in claim 2, wherein each engaging slot of the rotary table is provided with a nut that has a thread hole; when the adapter plate and the base plate are engaged, the plurality of engaging elements pass through the plurality of engaging holes and thread into the plurality of thread holes.

4. The detachable fixture device as claimed in claim 2, wherein an alignment element is disposed on the bottom surface of the adapter plate in a position corresponding to one of the engaging slots; when the adapter plate and the rotary table are engaged, the alignment element is inserted into one corresponding engaging slot and fits a slot wall of the corresponding engaging slot.

5. The detachable fixture device as claimed in claim 1, wherein the top surface of the adapter plate has at least one upper positioning hole; the base plate has at least one lower positioning hole in a position corresponding to the at least one upper positioning hole; the adapter plate and the base plate are positioned through at least one positioning element engaging in the at least one upper positioning hole and the at least one lower positioning hole.

6. The detachable fixture device as claimed in claim 5, wherein the at least one upper positioning hole includes a first upper positioning hole; the at least one lower positioning hole includes a first lower positioning hole; the at least one positioning element includes a first positioning element that has a head and a body connected to each other, with the head inserted into the first upper positioning hole and the body inserted into the first lower positioning hole.

7. The detachable fixture device as claimed in claim 6, wherein the first upper positioning hole is located in a center of the top surface of the adapter plate.

8. The detachable fixture device as claimed in claim 6, wherein the at least one upper positioning hole includes a second upper positioning hole; the at least one lower positioning hole includes a second lower positioning hole; the at least one positioning element includes a second positioning element that is a positioning pin; one end of the second positioning element is inserted into the second upper positioning hole and the other end of the second positioning element is inserted into the second lower positioning hole.

9. The detachable fixture device as claimed in claim 1, wherein the top surface of the adapter plate is provided with a plurality of thread holes that are arranged radially outward from a center of the top surface of the adapter plate; the base plate has a plurality of through holes in positions corresponding to a part of the plurality of thread holes; the base plate and the adapter plate are engaged through a plurality of engaging elements passing through the plurality of through holes and threading into the corresponding thread holes.
